(19) United States
(12) Patent Application Publication
(10) Pub. No.: US 2023/0295414 A1
(43) Pub. Date: Sep. 21, 2023

(54) A SLOW REACTING RECYCLABLE EPOXY RESIN SYSTEM FOR STRUCTURAL COMPOSITES

(71) Applicant: Aditya Birla Chemicals (Thailand) Ltd. (Advanced Materials), Bangkok (TH)

(72) Inventors: Pradip Kumar Dubey, Rayong (TH); Amit Dixit, Rayong (TH); Sirirat Changmongkol, Rayong (TH); Kanchana Inchamnan, Rayong (TH); Wasinee Sakathok, Rayong (TH)

(21) Appl. No.: 17/791,544

(22) PCT Filed: Jan. 5, 2021
(86) PCT No.: PCT/IB21/50033

§ 371 Date: Jul. 8, 2022

(30) Foreign Application Priority Data
Jan. 11, 2020 (IN) 202013001300

(51) Int. Cl. C08L 63/00; C08J 11/26

(52) U.S. Cl. CPC C08L 63/00; C08J 11/26; C08J 2363/00; C08J 2463/00

(57) ABSTRACT

A slow reacting recyclable epoxy resin system for structural composites is disclosed. The slow reacting recyclable epoxy resin system comprises an epoxy resin component comprising a high purity epoxy resin selected from a high purity Bisphenol A (BPA) epoxy resin, a high purity Bisphenol F (BPF) epoxy resin and a combination thereof wherein the high purity epoxy resin is in a range of 20 to 95 wt. % of the total weight of the epoxy resin component, a standard epoxy resin selected from a standard bisphenol A (BPA) epoxy resin, a standard Bisphenol F (BPF) epoxy resin and a combination thereof wherein the standard epoxy resin is in a range of 1 to 50 wt. % of the total weight of the epoxy resin component; and a curing agent component comprising a curing agent having at least one cleavage linkage selected from a group comprising of an acetal linkage, a ketal linkage, a formal linkage, an orthoester linkage or a siloxy linkage. The pot life of the slow reacting recyclable epoxy resin system is more than 540 minutes at 25° C.

### FIELD OF THE INVENTION

The present disclosure relates to an epoxy resin system. Specifically, the disclosure relates to a slow reacting recyclable epoxy resin system for structural composites.

### BACKGROUND

Epoxy resins are class of synthetic resins that are used in a wide range of applications. Epoxy resins offer a unique combination of properties that are unattainable with other thermoset resins. Due to the excellent physical and chemical properties, the epoxy resins have been widely used as adhesives, in coatings, as matrix resin in polymer composites for wind turbine rotor blades, aerospace and automotive etc.

The applicant has filed an Indian patent application No. 201711032920 dated Sep. 18, 2017 in respect of a slow reacting epoxy resin system. The slow reacting epoxy resin system of said application comprises a high purity epoxy resin component along with an amine curing agent. The high purity epoxy resin component has impurities of less than 5000 ppm and is selected from a group comprising of a high purity Bisphenol A (BPA) epoxy resin, a high purity Bisphenol F (BPF) epoxy resin, and a combination thereof. The slow reacting epoxy resin system of Indian patent Application no 201711032920, has an initial viscosity, i.e., the viscosity measured immediately after mixing the high purity epoxy resin component with the amine curing agent of less than 350 mPas at 25° C. Moreover, the strength development (Tg) of the slow reacting epoxy resin system is achieved in 4 to 6 hours and it has a pot-life of 420-500 minutes.

In certain applications, such as high-performance structural composites, there is a need that the epoxy resin system displays an optimum combination of processing and performance properties. For demanding applications such as wind turbine rotor blades, the focus has been on further improving processing properties such as a lower initial mix viscosity, slower rise in viscosity and longer pot-life. These properties not only allow larger working time but also improve the impregnation of the reinforcement material during the manufacturing of composite. In addition to these properties, it is also required that the epoxy resin system should possess high tensile strength and high fatigue resistance.

While, on one hand, there is a requirement of producing composites that have high performance properties such as tensile strength, on the other hand, it is also desirable that the composite be recyclable in nature to enable waste management especially at the end of the service life of composite part. Traditionally, the epoxy resin systems have a three-dimensional cross-linked network structure, they do not disintegrate or break down. As more and more applications now use such epoxy resin composition structures, the end of life management is becoming a compelling issue. Typical methods for disposal of epoxy resin based composite structures such as rotor blades include incineration which causes a detrimental environmental impact. Other recycling methods are energy-intensive processes and do not serve as a full proof and cost economical measure.

Therefore, there is a need for epoxy resin systems that have desirable processing and performance properties and are also recyclable in nature.

### BRIEF DESCRIPTION OF DRAWINGS

FIG. 1 illustrates viscosity development of a slow reacting recyclable epoxy resin system A in accordance with an embodiment of the present disclosure.

FIG. 2 illustrates viscosity development of a slow reacting recyclable epoxy resin system B in accordance with an embodiment of the present disclosure.

FIG. 3 illustrates strength development of the slow reacting recyclable epoxy resin system A in accordance with an embodiment of the present disclosure.

FIG. 4 illustrates strength development of the slow reacting recyclable epoxy resin system B in accordance with an embodiment of the present disclosure.

FIG. 5 illustrates working time of the slow reacting recyclable epoxy resin system A in accordance with an embodiment of the present disclosure.

FIG. 6 illustrates working time of the slow reacting recyclable epoxy resin system B in accordance with an embodiment of the present disclosure.

FIG. 7 illustrates the recycling process of the specimen of a composite made from a slow reacting recyclable epoxy resin system in accordance with an embodiment of the present disclosure.

FIG. 8 illustrates the recovery process of an epoxy resin component (s) in the form of a thermoplastic polymer in accordance with an embodiment of the present disclosure.

FIG. 9 schematic illustrating the curing of the epoxy resin component with the cleavable curing agent having cleavage points in comparison with the conventional epoxy resin system.

### SUMMARY OF THE INVENTION

The present disclosure relates to a slow reacting recyclable epoxy resin system for structural composites. The slow reacting recyclable epoxy resin system comprises an epoxy resin component comprising a high purity epoxy resin selected from a high purity Bisphenol A (BPA) epoxy resin, a high purity Bisphenol F (BPF) epoxy and a combination thereof wherein the high purity epoxy resin is in a range of 20 to 95 wt. % of the total weight of the epoxy resin component, a standard epoxy resin selected from a standard Bisphenol A (BPA) epoxy resin, a standard Bisphenol F (BPF) epoxy resin and a combination thereof wherein the standard epoxy resin is in a range of 1 to 50 wt. % of the total weight of the epoxy resin component and a curing agent component comprising a curing agent having at least one cleavage linkage selected from a group comprising of an acetal linkage, a ketal linkage, a formal linkage, an orthoester linkage or a siloxy linkage.

The present disclosure also relates to a slow reacting recyclable epoxy resin system for structural composites. The slow reacting recyclable epoxy resin system comprises an epoxy resin component selected from a group comprising of a high purity Bisphenol A (BPA) epoxy resin, a high purity Bisphenol F (BPF) epoxy resin and a combination thereof and; a curing agent component comprising a curing agent having at least one cleavage linkage selected from a group comprising of an acetal linkage, a ketal linkage, a formal linkage, an orthoester linkage or a siloxy linkage.

### DETAILED DESCRIPTION OF THE INVENTION

The invention as described therein is an improvement over the applicants ‘earlier filed Patent Application No. 201711032920 dated Sep. 18, 2017.

For the purpose of promoting an understanding of the principles of the invention, reference will now be made to embodiments and specific language will be used to describe the same. It will nevertheless be understood that no limitation of the scope of the invention is thereby intended, such alterations and further modifications in the disclosed process, and such further applications of the principles of the invention therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “one embodiment” “an embodiment” or similar language means that a particular feature, structure, or characteristic described in connection with the embodiment is included in at least one embodiment of the present invention. Thus, appearances of the phrase “in one embodiment”, “in an embodiment” and similar language throughout this specification may, but do not necessarily, all refer to the same embodiment.

The present disclosure relates to a slow reacting recyclable epoxy resin system. The slow reacting recyclable epoxy resin system comprises of an epoxy resin component and a curing agent component.

The term “slow reacting epoxy resin system” in context of the present disclosure means a system in which the epoxy resin component reacts slowly with the curing agent component to develop cross-linked network structure. Specifically, the term “slow reacting epoxy resin system” in context of the present disclosure means a system in which the initial mix viscosity is less than 220 mPa·s and pot life is more than 540 minutes at 25° C.

The term “initial mix viscosity” in context of the present disclosure means the viscosity of the epoxy resin system measured immediately after mixing the epoxy resin component and the curing agent component.

The term “pot life” in the context of the present disclosure is defined as the amount of time it takes for 1000 gms. mixture of epoxy resin component and curing agent component to reach 60° C. The time starts from the moment when the epoxy resin component and the curing agent component are mixed and is measured at room temperature (25° C.).

The term “recyclable epoxy resin system” in context of the present disclosure means a system in which the cross linked network structure is capable of disintegrating in the presence of heat, and an acid, resulting in the recovery of the reinforcement material from the composite and epoxy resin matrix as a thermoplastic.

### The Epoxy Resin Component:

The epoxy resin component comprises a high purity epoxy resin and a standard epoxy resin.

In accordance with an embodiment, the high purity epoxy resin is selected from a group comprising of a high purity Bisphenol A (BPA) epoxy resin, a high purity Bisphenol F (BPF) epoxy resin and a combination thereof. In accordance with an embodiment, the standard epoxy resin comprises a standard Bisphenol A (BPA) epoxy resin, a standard Bisphenol F (BPA) epoxy resin and a combination thereof.

In accordance with an embodiment, the epoxy resin component comprises the high purity Bisphenol A (BPA) epoxy resin, the high purity Bisphenol F (BPF) epoxy resin, and the standard Bisphenol A (BPA) epoxy resin.

In accordance with an embodiment, the epoxy resin component comprises the high purity Bisphenol A (BPA) epoxy resin, the high purity Bisphenol F (BPF) epoxy resin, and the standard Bisphenol F (BPF) epoxy resin.

In accordance with an embodiment, the epoxy resin component comprises the high purity Bisphenol A (BPA) epoxy resin, and the standard Bisphenol F (BPF) epoxy resin.

In accordance with an embodiment, the epoxy resin component comprises the high purity Bisphenol A (BPA) epoxy resin, and the standard Bisphenol A (BPA) epoxy resin.

In accordance with an embodiment, the epoxy resin component comprises the high purity Bisphenol F (BPF) epoxy resin, and the standard Bisphenol A (BPA) epoxy resin.

In accordance with an embodiment, the epoxy resin component comprises the high purity Bisphenol F (BPF) epoxy resin, and the standard Bisphenol F (BPF) epoxy resin.

In accordance with an embodiment, the epoxy resin component comprises the high purity Bisphenol A (BPA) epoxy resin, the high purity Bisphenol F (BPF) epoxy resin, the standard Bisphenol A (BPA) epoxy resin, and the standard Bisphenol F (BPF) epoxy resin.

In accordance with an embodiment, the epoxy resin component comprises the high purity Bisphenol A (BPA) epoxy resin, the high purity Bisphenol F (BPF) epoxy resin and a combination thereof.

In accordance with an embodiment, the high purity epoxy resin is in a range of 20 to 95% of the total weight of the epoxy resin component and the standard epoxy resin is in a range of 1 to 50 wt. % of the total weight of the epoxy resin component.

In accordance with an embodiment, the epoxy resin component comprises the high purity Bisphenol (A) (BPA) epoxy resin in a range of 20 to 60 wt. % of the total weight of the epoxy resin component, the high purity Bisphenol F (BPF) epoxy resin is in a range of 20 to 50 wt. % of the total weight of the epoxy resin component, and the standard epoxy resin is in a range of 5 to 40% of the total weight of the epoxy resin component.

In accordance with an embodiment, the epoxy resin component comprises 50 to 85 wt. % of the high purity Bisphenol A (BPA) epoxy resin and 25 to 50 wt. % of the high purity Bisphenol F (BPF) of the total weight of the epoxy resin component.

The high purity Bisphenol A (BPA) epoxy resin and the high purity Bisphenol F (BPF) epoxy resin possesses high monomer content and lower impurities. In accordance with an embodiment, the high purity Bisphenol A (BPA) epoxy resin and the high purity Bisphenol F (BPF) epoxy resin should each have impurities less than 5000 ppm, such that the total amount of impurities that are present in the combined amount of high purity Bisphenol A (BPA) epoxy resin and the high purity Bisphenol F (BPF) epoxy resin is less than 5000 ppm. In accordance with an aspect, the epoxy resin component that includes the high purity Bisphenol A (BPA) epoxy resin, the high purity Bisphenol F (BPF) epoxy resin and the standard Bisphenol A (BPA) epoxy resin will have impurities less than 6,000 ppm.

The high purity Bisphenol A (BPA) epoxy resin and high purity Bisphenol F (BPF) epoxy resin can be obtained using known purification methods which include filtration, and distillation. Alternatively, any commercially available high purity Bisphenol A (BPA) epoxy resin or high purity Bisphenol F (BPF) epoxy resin can be used.

By keeping the impurities in the range disclosed above results in slower reactivity of the components which facilitates improved impregnation of reinforcement during composite processing by infusion process and contributes in the elimination of process defects such as dry areas and wrinkles.

In accordance with an embodiment, the high purity Bisphenol A (BPA) epoxy resin has an epoxy equivalent weight (EEW) in a range of 170 to 183 gm/eq. In accordance with an embodiment, the high purity Bisphenol F (BPF) epoxy resin has an epoxy equivalent weight (EEW) in a range of 155 to 165 gm/eq. In accordance with an embodiment, the standard Bisphenol A (BPA) epoxy resin has an epoxy equivalent weight (EEW) in a range of 184 to 190 gm/eq. In accordance with an embodiment, the standard Bisphenol F (BPF) epoxy resin has an epoxy equivalent weight in a range of 170 to 180 gm/eq.

The term “epoxy equivalent weight” in the context of the present disclosure means “the weight of resin in grams that contains one equivalent of epoxy”.

In accordance with an embodiment, the high purity Bisphenol A (BPA) epoxy resin has a monomer content in a range of 85% to 99.9%.

In accordance with an embodiment, the viscosity of the epoxy resin component is in a range of 700 to 2000 mPa·s.

### The Curing Agent Component:

The curing agent component of the slow reacting recyclable epoxy resin system comprises of a curing agent having at least one cleavage linkage. The cleavable linkage includes either an acetal linkage, a ketal linkage, a formal linkage, an orthoester, orthocarbonate linkage, and a siloxy linkage.

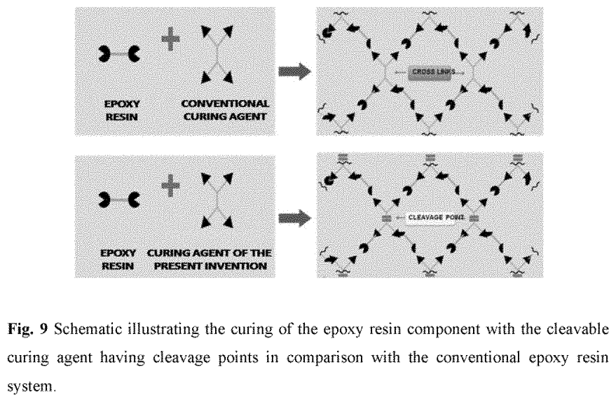

The cleavage linkages are disintegrated upon exposure to elevated temperature in an acidic medium. Thus, the dissolution of the slow reacting recyclable epoxy resin system is the result of the disintegration of these linkages in the cross-linked network structure of the epoxy resin system which allows the epoxy resin system to be recyclable. FIG. 9 shows the schematic of the curing of the epoxy resin component with the cleavable curing agent having cleavage points in comparison with the conventional epoxy resin system.

In accordance with an embodiment, the curing agent is selected from a group comprising of 2,2-bis (2-aminopropoxy) propane, and tri (2-aminobutoxy) methyl silane.

In accordance with an embodiment, the curing agent is in a range of 80 to 100 wt. % of the total weight of the curing agent component.

In accordance with an embodiment, the epoxy resin component and the curing agent component in the slow reacting recyclable epoxy resin system are added in a w/w ratio in a range of 100:10 to 100:50. In an example, the epoxy resin component and the curing agent component are added in a w/w ratio in a range of 100:25 to 100:35. The ratio of the epoxy resin component, and the curing agent component in the slow reacting recyclable epoxy resin system depends on the intended use and application of the epoxy resin system.

In accordance with an embodiment, the initial viscosity of the slow reacting recyclable epoxy resin system after mixing the epoxy resin component and the curing agent component is less than 220 mPas at 25° C. In accordance with an embodiment, the initial mix viscosity of the slow reacting recyclable epoxy resin system after mixing the epoxy resin component and the curing agent component is less than 200 mPas at 40° C. In accordance with an embodiment, the initial viscosity of the slow reacting recyclable epoxy resin system is further reduced to less than 170 mPas if the epoxy resin component and the curing component are pre-heated and mixed at higher temperature up-to 80° C. The term “initial viscosity” in context of the present disclosure means the viscosity measured immediately after mixing various components. Accordingly, the term “initial viscosity of the slow reacting recyclable epoxy resin system” in context of the present disclosure means the viscosity measured immediately after mixing the epoxy resin component and the curing agent component.

In accordance with an embodiment, the pot-life of the slow reacting recyclable epoxy resin system is more than 540 minutes at 25° C. In accordance with another embodiment, the pot-life of the slow reacting recyclable epoxy resin system is in a range of 600 to 750 minutes at 25° C. In accordance with an embodiment, the pot life of the slow reacting recyclable epoxy resin system comprising the high purity Bisphenol A (BPA) epoxy resin, the high purity Bisphenol F (BPF) epoxy resin, the standard Bisphenol A (BPA) epoxy resin and tri (2-aminobutoxy)methyl silane is 749 minutes and 720 minutes. In accordance with an embodiment, the pot life of the slow reacting recyclable epoxy resin system comprising the high purity Bisphenol A (BPA) epoxy resin, the high purity Bisphenol F (BPF) epoxy resin, and 2,2-bis (2-aminopropoxy) propane is 645 minutes. Longer pot-life indicates longer working time, which is desired for improved impregnation of reinforcement, thus resulting in lower process defects. The term “pot life” in the context of the present disclosure is defined as the amount of time it takes for 1000 gms. mixture of epoxy resin component and curing agent component to reach 60° C. The time starts from the moment when the epoxy resin component and the curing agent component are mixed and are measured at room temperature (25° C.).

In accordance with an embodiment, the glass transition temperature (T_{g}) of the slow reacting recyclable epoxy resin system is more than 75° C.

The term “glass transition temperature” in the context of the present disclosure means the temperature range where the epoxy resin system changes from a hard, rigid or glassy state to a rubbery state. The unit of the glass transition temperature is ° C. (degree Celsius).

In accordance with an embodiment, the slow reacting recyclable epoxy resin system may further comprise additives. Said additives may be added as a separate component in addition to the epoxy resin component and the curing agent component. Alternatively, said additives form a part of the epoxy resin component or form a part of the curing agent component. In accordance with an embodiment, the total amount of additives in the slow reacting recyclable epoxy resin system does not exceed 25 wt. % of the total weight of the slow reacting recyclable epoxy resin system.

Additives include modifiers, diluents, latent curing agents, accelerators or combination thereof. The modifiers may be selected from defoamers, flow additives, rheological additives, fillers, air release additives, wetting agents and coupling agents. In accordance with an embodiment, the epoxy resin component further comprises a diluent. In accordance with an embodiment, diluent is selected from the group comprising of mono-, di-, tri-functional aliphatic and aromatic epoxidized reactive diluents and non-reactive diluents. Examples of the diluents include but are not limited to 1,4 butane diol diglycidyl ether, C12-C14 alkyl glycidyl ether, 1,6-hexanediol diglycidyl ether, cresyl glycidyl ether, trimethylolpropane triglycidyl ether and a combination thereof. In accordance with another embodiment the diluents may comprise of a high purity epoxidized reactive diluent. The high purity epoxidized reactive diluent possesses impurities less than 5000 ppm. Examples of the high purity epoxidized reactive diluents include but are not limited to a high purity 1-4 butane diol diglycidyl ether, a high purity 1-6 hexanediol diglycidyl ether, a high purity cresyl glycidyl ether, a high purity trimethylolpropane triglycidyl ether and a combination thereof.

In accordance with an embodiment, the high purity 1-4 butane diol diglycidyl ether has an epoxy equivalent weight in a range of 101 to 110 gm/eq. In accordance with an embodiment, the high purity 1-6 hexanediol diglycidyl ether has an epoxy equivalent weight in a range of 115 to 130 gm/eq. In accordance with an embodiment, the high purity cresyl glycidyl ether has an epoxy equivalent weight in a range of 164 to 174 gm/eq. In accordance with an embodiment, the high purity trimethylolpropane triglycidyl ether has an epoxy equivalent weight in a range of 106 to 120 gm/eq.

The selection of said additives is based on attributes or characteristics required in the slow reacting recyclable epoxy resin system and the end-use or the intended application of the slow reacting recyclable epoxy resin system.

For example, diluents may be added to the slow reacting recyclable epoxy resin system to further lower the “initial viscosity of the epoxy resin system”. These additives may be added to the slow reacting recyclable epoxy resin system to achieve initial viscosity even lower than 220 mPa·s. By way, a specific example, addition of diluents enables achieving an initial viscosity in the range of 150 to 250 mPa·s at 25° C. As herein refers to “initial viscosity” of slow reacting recyclable epoxy resin system means the viscosity measured immediately after mixing the epoxy resin component, the curing agent component and the additives.

By way of another example, the curing agent component may further comprise additives. Examples of additives that may be added to the curing agent component includes but are not limited to latent curing agent with secondary amines, tertiary amines, accelerators or other additives. In accordance with an embodiment, the additive added to the curing component is an imidazole derivative or a guanidine derivative. In accordance with an embodiment, the curing agent component comprises additive in a range of 0 to 20 wt. % of the total weight of the curing agent component.

The present disclosure also provides a method of preparing a slow reacting recyclable epoxy resin system. The method comprising mixing the epoxy resin component and the curing agent component as described above. Any known method may be used to mix the epoxy resin component and the curing agent component, for example using magnetic stirrers, by hand mixing, static mixers, or other suitable mixing method.

The present disclosure can be further used for producing composite. The composite comprises of the slow reacting recyclable epoxy resin system as polymer matrix and a reinforcement material, wherein the slow reacting recyclable epoxy resin system comprises of the epoxy resin component and the curing agent component. In accordance with an embodiment, the reinforcement material is selected from a group comprising of glass fiber, carbon fiber, poly-aramid fiber.

In accordance with an embodiment, the composite is prepared by at least one method selected from a group consisting of wet lay-up, infusion, and vacuum assisted resin transfer molding (VARTM).

The composite produced in accordance with the present disclosure may be cured at room temperature. Alternately, for complete cross linking and attaining optimum mechanical properties, the composite can be cured at elevated temperature. For heat curing, the composite is subjected to heating at a predetermined temperature for a predetermined period of time.

In accordance with an embodiment, the tensile strength of the composite made from the slow reacting recyclable epoxy resin system is in a range of 840 to 860 MPa. In a specific embodiment, the tensile strength of the composite made from the slow reacting recyclable epoxy resin system is 856.48 MPa.

In accordance with an embodiment, the shear strength of the composite made from the slow reacting recyclable epoxy resin system is in a range of 40 to 50 MPa. In a specific embodiment, the shear strength of the composite made from the slow reacting epoxy resin system is 45.19 MPa.

The tensile strength and the shear strength of the composite made from the slow reacting recyclable epoxy resin system is increased because of the improved coupling between the reinforcement material and the slow reacting recyclable epoxy resin system. The performance properties such as higher tensile strength and shear strength are responsible for the higher mechanical strength of the composite.

In accordance with an aspect, a process for recycling the slow reacting recyclable epoxy resin system and the composite is also disclosed. The process comprises of immersing the composite in an acid solution at an elevated temperature. The immersion of the composite in the acid solution will induce cleavage of the cross-linked network of the cured slow reacting epoxy resin system and the conversion of the epoxy resin component (s) into a thermoplastic polymer. The cross-linked network of the slow reacting recyclable epoxy resin system disintegrates, resulting in the recovering of the reinforcement material from the composite.

In accordance with an embodiment, the composite is heated to a temperature in a range of 70° C. to 90° C. In accordance with an embodiment, the composite is immersed in the acid solution for a sufficient period for the dissolution of the epoxy resin component (s). The period that is required for dissolution of the slow reacting recyclable epoxy resin system ranges from 2 to 24 hours.

In accordance with an embodiment, the acid in which the slow reacting recyclable epoxy resin system is immersed is selected from a group comprising of a strong proton donor acid compound and a weak proton donor acid compound. The acid selection is done on the basis of time required for cleavage, and the temperature. Example of the acid includes but are not limited to methane sulphonic acid, para toluene sulphonic acid, versatic acid, acetic acid, hydrochloric acid, sulphuric acid, phosphoric acid.

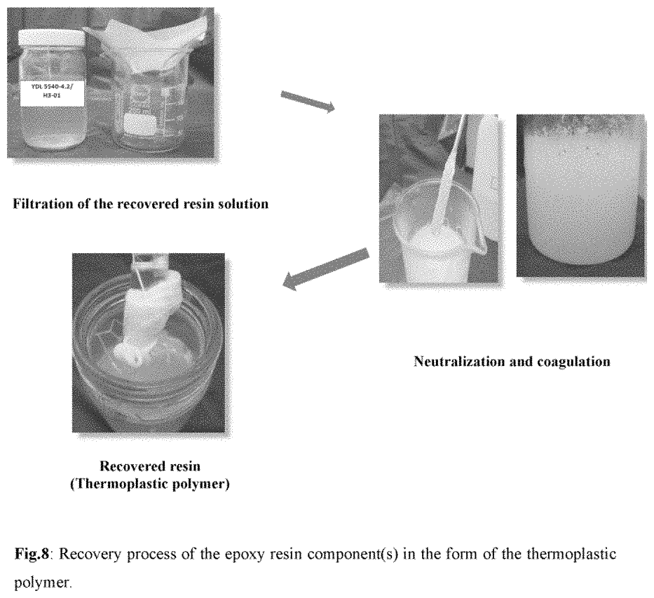

In accordance with an embodiment, the process further comprises a step of recovering the epoxy resin component(s) via a filtration process and a precipitation process. FIG. 8 illustrates the recovery process of the epoxy resin component (s) in the form of the thermoplastic polymer.

The invention will now be described with respect to the following examples which do not limit the invention in any way and only exemplify the invention.

### EXAMPLES

### Example 1: Preparation of the Slow Reacting Recyclable Epoxy Resin System in Accordance with an Embodiment of the Present Disclosure

TABLE 1
The slow reacting recyclable epoxy resin system formulation

| | | | Slow reacting | Slow reacting | Slow reacting |
|---|---|---|---|---|---|
| | Conventional | Conventional | recyclable | recyclable | recyclable |
| | epoxy resin | epoxy resin | epoxy resin | epoxy resin | epoxy resin |
| | system A | system B | system A | system B | system C |
| Composition | (wt. %) | (wt. %) | (wt. %) | (wt. %) | (wt. %) |
| High purity | — | — | 35 | 37 | 70 |
| Bisphenol A | | | | | |
| (BPA) epoxy | | | | | |
| resin | | | | | |
| High purity | — | — | 23 | 23 | 30 |
| Bisphenol F | | | | | |
| (BPF) epoxy | | | | | |
| resin | | | | | |
| Standard | 90 | 90 | 35 | 35 | — |
| Bisphenol A | | | | | |
| (BPA) resin | | | | | |
| Standard | — | — | — | — | — |
| Bisphenol F | | | | | |
| (BPF) epoxy | | | | | |
| resin | | | | | |
| 2,2-bis (2- | 28 | — | 29 | — | 30 |
| aminopropoxy) | | | | | |
| propane | | | | | |
| Tri (2- | — | 30 | — | 32 | — |
| aminobutoxy) | | | | | |
| methyl silane | | | | | |
| High purity | — | — | — | — | — |
| 1,4 butane diol | | | | | |
| diglycidyl ether | | | | | |
| 1,4 butane diol | 4 | 4 | — | — | — |
| diglycidyl ether | | | | | |
| C12-C14 alkyl | 6 | 6 | 7 | 5 | — |
| glycidyl ether | | | | | |
| Mixing ratio | 100:28 | 100:30 | 100:29 | 100:32 | 100:30 |
| by weight | | | | | |
| (Epoxy resin | | | | | |
| component:Curing | | | | | |
| component | | | | | |
| % of diluent | 7.81 | 7.69 | 5.43 | 3.79 | — |

| | Slow reacting | Slow reacting | Slow reacting | Slow reacting |
|---|---|---|---|---|
| | recyclable | recyclable | recyclable | recyclable |
| | epoxy resin | epoxy resin | epoxy resin | epoxy resin |
| | system D | system E | system F | system G |
| Composition | (wt. %) | (wt. %) | (wt. %) | (wt. %) |
| High purity | 65 | 73 | 50 | 94 |
| Bisphenol A | | | | |
| (BPA) epoxy | | | | |
| resin | | | | |
| High purity | 30 | 15 | 50 | — |
| Bisphenol F | | | | |
| (BPF) epoxy | | | | |
| resin | | | | |
| Standard | — | 5 | — | — |
| Bisphenol A | | | | |
| (BPA) resin | | | | |
| Standard | 5 | — | — | — |
| Bisphenol F | | | | |
| (BPF) epoxy | | | | |
| resin | | | | |
| 2,2-bis (2- | — | — | — | — |
| aminopropoxy) | | | | |
| propane | | | | |
| Tri (2- | 32 | 32 | 33 | 33 |
| aminobutoxy) | | | | |
| methyl silane | | | | |
| High purity | — | — | — | 6 |
| 1,4 butane diol | | | | |
| diglycidyl ether | | | | |
| 1,4 butane diol | — | — | — | — |
| diglycidyl ether | | | | |
| C12-C14 alkyl | — | 7 | — | — |
| glycidyl ether | | | | |
| Mixing ratio | 100:32 | 100:32 | 100:33 | 100:33 |
| by weight | | | | |
| (Epoxy resin | | | | |
| component:Curing | | | | |
| component | | | | |
| % of diluent | — | 5.30 | — | 4.51 |

The Slow Reacting Recyclable Epoxy Resin System Preparation:

The slow reacting recyclable epoxy resin system A was prepared by mixing the high purity Bisphenol A (BPA) epoxy resin, the high purity Bisphenol F (BPF) epoxy resin, the standard Bisphenol A (BPA) epoxy resin, C12-C14 alkyl glycidyl ether, and 2, 2-bis (2-aminopropoxy) propane in specific percentage as mentioned in Table 1 above at 25° C. The slow reacting recyclable epoxy resin systems B and E were prepared by mixing the high purity Bisphenol A (BPA) epoxy resin, the high purity Bisphenol F (BPF) epoxy resin, the standard Bisphenol A (BPA) epoxy resin, C12-C14 alkyl glycidyl ether, and tri (2-aminobutoxy) methyl silane in specific percentage as mentioned in Table 1 above at 25° C. The slow reacting recyclable epoxy resin system C was prepared by mixing the high purity Bisphenol A (BPA) epoxy resin, the high purity Bisphenol F (BPF) epoxy resin (BPF), and 2, 2-bis (2-aminopropoxy) propane in specific percentage as mentioned in Table 1 above at 25° C. The slow reacting recyclable epoxy resin system D was prepared by mixing the high purity Bisphenol A (BPA) epoxy resin, the high purity Bisphenol F (BPF) epoxy resin, the standard Bisphenol F (BPF) epoxy resin and tri (2-aminobutoxy) methyl silane in specific percentage as mentioned in Table 1 above at 25° C. The slow reacting recyclable epoxy resin system F was prepared by mixing the high purity Bisphenol A (BPA) epoxy resin, the high purity Bisphenol F (BPF) epoxy resin (BPF), and tri (2-aminobutoxy) methyl silane in specific percentage as mentioned in Table 1 above at 25° C. The slow reacting recyclable epoxy resin system G was prepared by mixing the high purity Bisphenol A (BPA) epoxy resin, tri (2-aminobutoxy) methyl silane and the high purity 1,4 butane di-ol diglycidyl ether in specific percentage as mentioned in Table 1 above at 25° C.

Conventional Epoxy Resin System Preparation:

The conventional epoxy resin system A was prepared by using standard Bisphenol A (BPA) epoxy resin, C12-C14 alkyl glycidyl ether, 1,4 butane diol diglycidyl ether, and 2, 2-bis (2-aminopropoxy) propane in specific percentage as mentioned above in Table 1 above. A conventional epoxy resin system B was prepared by using standard Bisphenol A (BPA) epoxy resin, C12-C14 alkyl glycidyl ether, 1,4 butane diol diglycidyl ether, and tri (2-aminobutoxy) methyl silane in specific percentage as mentioned above in Table 1 above.

The properties of high purity Bisphenol A (BPA) epoxy resin used in preparation of the slow reacting recyclable epoxy resin system A, B, C, D, E, F, and G in terms of the Epoxy equivalent weight (EEW), monomer content, hydroxy value and impurities are provided below in Table 2.

TABLE 2
Properties of High purity Bisphenol A (BPA) epoxy resin

| | | | Slow reacting | Slow reacting |
|---|---|---|---|---|
| | | Slow reacting | recyclable | recyclable |
| | | recyclable | epoxy resin | epoxy resin |
| | | epoxy resin | systems B, D, | systems C, E, |
| Properties | Range | system A | and F | and G |
| EEW | 170-183 | 174.1 | 175.1 | 173.5 |
| | gm/eq | | | |
| Monomers | 85-99.9% | 98.8 | 97.4 | 98.9 |
| Hydroxy | <1000 | 350 | 350 | 260 |
| value | mgKOH/g | | | |
| Impurity | <5000 | 2500 | 2900 | 2,100 |
| | ppm | | | |

The properties of high purity Bisphenol F epoxy resin (BPF) used in preparation of the slow reacting recyclable epoxy resin system A, B, C, D, E, and F in terms of Epoxy equivalent weight (EEW), hydroxy value and impurities are given in Table 3 below.

TABLE 3
Properties of High purity Bisphenol F (BPF) epoxy resin

| | | | Slow reacting | Slow reacting |
|---|---|---|---|---|
| | | Slow reacting | recyclable | recyclable |
| | | recyclable | epoxy resin | epoxy resin |
| | | epoxy resin | systems B, D, | systems C, |
| Properties | Range | system A | and F | and E |
| Epoxy | 155-165 | 159.7 | 156.3 | 160.1 |
| equivalent | gm/eq | | | |
| weight | | | | |
| (EEW) | | | | |
| Hydroxy | <1000 | 410 | 350 | 450 |
| value | mgKOH/g | | | |
| Impurity | <5000 | 3100 | 1040 | 3,250 |
| | ppm | | | |

Product Characterization:

Process and performance properties of the slow reacting recyclable epoxy resin system A, B, C, D, E, F and G and the conventional epoxy resin system A and B were conducted by standard methods.

Table 4 below provides the processing properties including initial mix viscosity, glass transition temperature, pot life of 1 Kg mix at 25° C. and rise in viscosity up to 1000 mPa·s at 30° C. of the slow reacting recyclable epoxy resin systems A, B, C, D, E, F and G and of the conventional epoxy resin systems A and B. As it can be observed from the table 4, the initial mix viscosity of the slow reacting recyclable epoxy resin systems A, B, C, D, E, F and G is 190 mPa·s, 206 mPa·s, 212 mPa·s, 217.6 mPa·s, 203.2, 216.3, 203.3 mPa·s respectively. On the other hand, the initial mix viscosity of the conventional epoxy resin systems A and B is 280 mPa·s and 261.2 mPa·s respectively.

The pot life of the slow reacting recyclable epoxy resin system A to G is significantly longer than the pot life of the conventional epoxy resin systems A and B. The pot life of the slow reacting recyclable epoxy resin systems A, B, C, D, E, F and G and is 609 minutes, 749 minutes, 645 minutes, 603 minutes, 720 minutes, 541 minutes and 567 minutes respectively. In contrast, the pot-life of the conventional epoxy resin systems A and B is 468 minutes and 530 minutes respectively. Longer pot life provides longer working time, which is desired for improved impregnation of reinforcement, thus resulting in lesser process defects.

TABLE 4
Processing Properties of the slow reacting recyclable epoxy resin systems
A to G compared with the conventional epoxy resin systems A and B.

| | | | | | Slow reacting | Slow reacting | Slow reacting |
|---|---|---|---|---|---|---|---|
| | | | Conventional | Conventional | recyclable | recyclable | recyclable |
| Processing | Test | | epoxy resin | epoxy resin | epoxy resin | epoxy resin | epoxy resin |
| Properties | method | Unit | system A | system B | system A | system B | system C |
| Initial mix | ASTM | mPa · s | 280.7 | 261.2 | 190.0 | 206.7 | 212.0 |
| viscosity | D 2196 | | | | | | |
| @25° C. | | | | | | | |
| Initial mix | ASTM | mPa · s | 232.1 | 221.3 | 156.0 | 161.0 | 165.3 |
| viscosity | D 2196 | | | | | | |
| @40° C. | | | | | | | |
| Glass | ISO | deg. C. | 73.81 | 72.01 | 78.79 | 80.46 | 81.1 |
| transition | 11357-2 | | | | | | |
| temperature | | | | | | | |
| (Tg) | | | | | | | |
| Pot life, | ASTM | minutes | 468 | 530 | 609 | 749 | 645 |
| 1 kg mix | D 2471 | | | | | | |
| @ 25° C. | | | | | | | |
| Rise in | ISO | minutes | 232 | 238 | 290 | 299 | 295 |
| viscosity | 3219 | | | | | | |
| @ 30° C. | | | | | | | |

| | Slow reacting | Slow reacting | Slow reacting | Slow reacting |
|---|---|---|---|---|
| | recyclable | recyclable | recyclable | recyclable |
| Processing | epoxy resin | epoxy resin | epoxy resin | epoxy resin |
| Properties | system D | system E | system F | system G |
| Initial mix | 217.6 | 203.2 | 216.3 | 203.3 |
| viscosity | | | | |
| @25° C. | | | | |
| Initial mix | 168.7 | 159.1 | 167.7 | 158.3 |
| viscosity | | | | |
| @40° C. | | | | |
| Glass | 79.31 | 76.12 | 81.49 | 83.01 |
| transition | | | | |
| temperature | | | | |
| (Tg) | | | | |
| Pot life, | 603 | 720 | 541 | 567 |
| 1 kg mix | | | | |
| @ 25° C. | | | | |
| Rise in | 289 | 284 | 278 | 293 |
| viscosity | | | | |
| @ 30° C. | | | | |

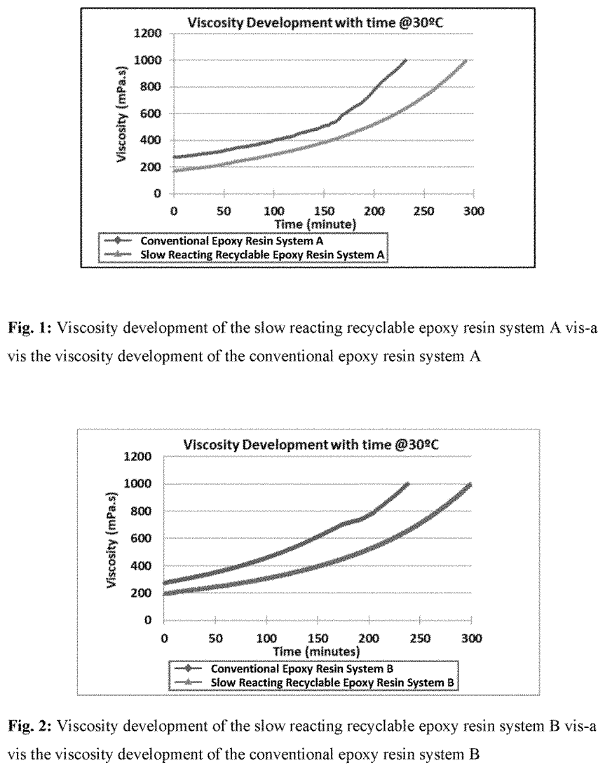

The viscosity development of the slow reacting recyclable epoxy resin systems A and B prepared in accordance with the present disclosure were measured at different time intervals. FIG. 1 illustrates that the rate of change of viscosity at 30° C. of the slow reacting recyclable epoxy resin system A, in accordance with the present disclosure and the conventional epoxy resin system A. FIG. 2 illustrates that the rate of change of viscosity at 30° C. of the slow reacting recyclable epoxy resin system B, in accordance with the present disclosure and the conventional epoxy resin system B. As it can be observed from FIG. 1 and FIG. 2, the viscosity of the slow reacting recyclable epoxy resin system A and the slow reacting recyclable epoxy resin system B increases gradually as compared to the conventional epoxy system A and the conventional epoxy resin system B. The slow rate of the viscosity development indicates slower reactivity of the slow reacting recyclable epoxy resin system A and B which is desired for improve impregnation of the reinforcement resulting in lower process defects.

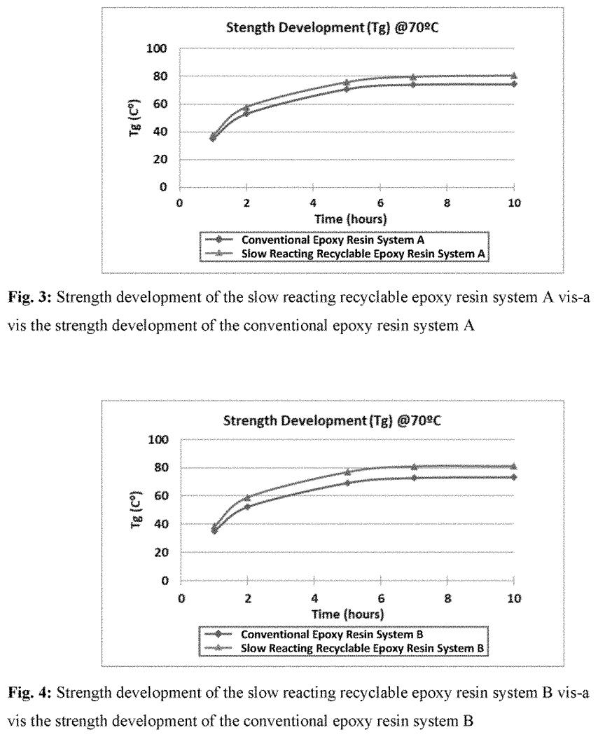

Further, the strength development of the slow reacting recyclable epoxy resin system A and the slow reacting recyclable epoxy resin system B were measured by post curing isothermally @ 70° C. and observing the strength development (Tg) value every 1 hour. FIG. 3 and FIG. 4 illustrates the strength development (Tg) of the slow reacting recyclable epoxy resin system A and the slow reacting recyclable epoxy resin system B, in accordance with the present disclosure, and the conventional epoxy system A and the conventional epoxy resin system B. As it can be observed from FIG. 3 and FIG. 4. the slow reacting recyclable epoxy resin system A and the slow reacting recyclable epoxy resin system B attains the optimum strength development (Tg) @ 70° C. (required for complete cross-linking and attaining optimum mechanical properties) in 6 hours. The faster strength development of the slow reacting recyclable epoxy resin system A and B indicates faster crosslinking during curing process which is desired for shorter in mold time. This feature contributes in reduced cycle time and increased productivity.

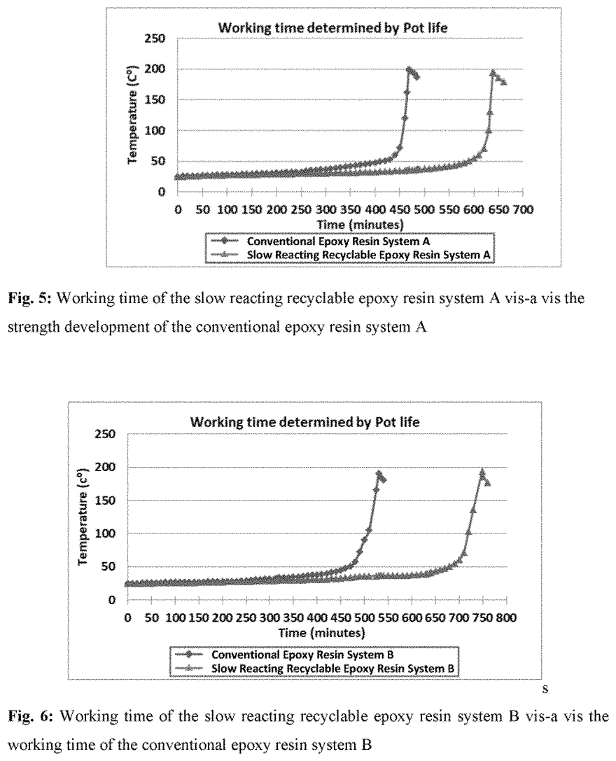

In addition, the working time of the slow reacting recyclable epoxy resin system A and the slow reacting recyclable epoxy system B were determined by the pot life of the slow reacting recyclable epoxy resin system. FIG. 5 and FIG. 6 illustrates the working time of the slow reacting recyclable epoxy resin system A and the slow reacting recyclable epoxy resin system B in accordance with the present disclosure and the working time of the conventional epoxy system A and the conventional epoxy resin system B. As it can be observed from table 4 above, the working time of the slow reacting recyclable epoxy resin system A and the slow reacting recyclable epoxy resin system B is 609 minutes and 749 minutes respectively. On the other hand, the working time of the conventional epoxy resin system A and the conventional epoxy resin system B is 468 minutes and 530 minutes respectively.

Table 5 below provides the comparison of the processing properties of the slow reacting recyclable epoxy resin system A to G of the present disclosure with the processing properties of the slow reacting epoxy resin systems 1 to 6 of Indian patent application No. 201711032920.

TABLE 5
Processing properties of the slow reacting recyclable epoxy resin systems A to G compared vis
a vis the slow reacting epoxy resin system 1 to 6 of Indian Patent application No. 201711032920

| | | | Slow | Slow | Slow | Slow | Slow | Slow |
|---|---|---|---|---|---|---|---|---|
| | | | reacting | reacting | reacting | reacting | reacting | reacting |
| Processing | Test | | epoxy resin | Epoxy resin | Epoxy resin | Epoxy resin | Epoxy resin | Epoxy resin |
| Properties | method | Unit | System 1 | System 2 | System 3 | System 4 | System 5 | system 6 |
| Initial mix | ASTM | mPa · s | 208.0 | 213.4 | 235.4 | 195.8 | 211.5 | 183.5 |
| viscosity | D 2196 | | | | | | | |
| @25° C. | | | | | | | | |
| Initial mix | ASTM | mPa · s | — | — | — | — | — | — |
| viscosity | D 2196 | | | | | | | |
| @40° C. | | | | | | | | |
| Glass | ISO | ° C. | 76.87 | 82.00 | 91.01 | 76.12 | 76.35 | 74.16 |
| transition | 11357 | | | | | | | |
| temperature | | | | | | | | |
| Pot life, | ASTM | Minutes | 383.0 | 471.0 | 437.0 | 488.0 | 365.0 | 474.0 |
| 1 kg mix | D 2471 | | | | | | | |
| @ 25° C. | | | | | | | | |
| Rise in | ISO | Minutes | 295.5 | 306.0 | 269.0 | 314.5 | 289.7 | 304.0 |
| viscosity | 3219 | | | | | | | |
| up to 1000 | | | | | | | | |
| mPa · s | | | | | | | | |
| @ 30° C. | | | | | | | | |

| | Slow | Slow | Slow | Slow | Slow | Slow | Slow |
|---|---|---|---|---|---|---|---|
| | reacting | reacting | reacting | reacting | reacting | reacting | reacting |
| | recyclable | recyclable | recyclable | recyclable | recyclable | recyclable | recyclable |
| Processing | Epoxy resin | Epoxy resin | Epoxy resin | Epoxy resin | Epoxy resin | Epoxy resin | Epoxy resin |
| Properties | system A | system B | system C | system D | system E | system F | system G |
| Initial mix | 190.0 | 206.7 | 212.0 | 217.6 | 203.2 | 216.3 | 203.3 |
| viscosity | | | | | | | |
| @25° C. | | | | | | | |
| Initial mix | 156.0 | 161.0 | 165.3 | 168.7 | 159.1 | 167.7 | 158.3 |
| viscosity | | | | | | | |
| @40° C. | | | | | | | |
| Glass | 78.79 | 80.46 | 81.1 | 79.31 | 76.12 | 81.49 | 83.01 |
| transition | | | | | | | |
| temperature | | | | | | | |
| Pot life, | 609 | 749 | 645 | 603 | 720 | 541 | 567 |
| 1 kg mix | | | | | | | |
| @ 25° C. | | | | | | | |
| Rise in | 290 | 299 | 295 | 289 | 284 | 278 | 293 |
| viscosity | | | | | | | |
| up to 1000 | | | | | | | |
| mPa · s | | | | | | | |
| @ 30° C. | | | | | | | |

### Observations:

As it can be observed from table 5, the pot life of the slow reacting epoxy resin system 1 to 6 is in the range of 383 to 474 minutes. In contrast, the pot life of the slow reacting recyclable epoxy resin systems A to G is in the range of 541 to 749 minutes The pot-life of the slow reacting recyclable epoxy resin systems A to G of the present disclosure is significantly improved as compared to the pot-life of the slow reacting epoxy resin systems 1 to 6 of the Indian patent application No. 201711032920. The longer pot-life of the slow reacting recyclable epoxy resin systems indicates longer working time which is desired for improved impregnation of the reinforcement material.

### Performance Properties of the Epoxy Resin System

Performance properties of the epoxy resin system are also measured. Table 6 illustrates the performance properties of the slow reacting recyclable epoxy resin systems A to G vis-à-vis the performance properties of the conventional epoxy resin system A and B.

TABLE 6
Performance properties of the slow reacting recyclable epoxy
resin system A to G in accordance with the present disclosure

| | | | | | | |
|---|---|---|---|---|---|---|
| | | | | | Slow | Slow |
| | | | | | reacting | reacting |
| | | | Conventional | Conventional | recyclable | recyclable |
| Performance | Test | | epoxy resin | epoxy resin | epoxy resin | epoxy resin |
| Properties | method | Unit | system A | system B | system A | system B |

The recyclable epoxy resin system

| | | | | | | |
|---|---|---|---|---|---|---|
| Tensile | ISO | | | | | |
| Test | 527-2 | | | | | |
| Tensile | | MPa | 66.47 | 66.98 | 71.53 | 73.84 |
| Strength | | | | | | |
| Tensile | | % | 4.21 | 4.11 | 4.34 | 4.76 |
| Strain | | | | | | |
| E-Modulus | | MPa | 2,785 | 2,712 | 3,018 | 2,870 |
| Flexural | ISO | | | | | |
| Test | 178 | | | | | |
| Flexural | | MPa | 116.58 | 115.46 | 125.45 | 120.92 |
| Strength | | | | | | |
| Flexural | | % | 6.01 | 6.34 | 5.86 | 6.12 |
| Strain | | | | | | |
| E-Modulus | | MPa | 2,945 | 2,931 | 3,227 | 3,040 |

Glass or carbon reinforced epoxy composite laminates

| | | | | | | |
|---|---|---|---|---|---|---|
| Tensile test | ISO | | | | | |
| 0° (UD) | 527-4 | | | | | |
| Tensile | | MPa | 811.12 | 813.15 | 856.48 | 852.47 |
| strength | | | | | | |
| Fracture | | % | 1.99 | 1.98 | 2.00 | 2.07 |
| strain | | | | | | |
| Modulus | | MPa | 43,595 | 43,604 | 44,355 | 44,113 |
| (Chord 0.05% | | | | | | |
| 0.25%) | | | | | | |
| Shear test ± | ISO | | | | | |
| 45° 2Ax | 14129 | | | | | |
| Shear | | MPa | 39.01 | 39.23 | 43.47 | 45.19 |
| strength | | | | | | |
| (at 5% | | | | | | |
| shear | | | | | | |
| strain) | | | | | | |
| Shear | | MPa | 3,254 | 3,266 | 3,554 | 3,554 |
| modulus | | | | | | |

| | | | | | |
|---|---|---|---|---|---|
| | Slow | Slow | Slow | Slow | Slow |
| | reacting | reacting | reacting | reacting | reacting |
| | recyclable | recyclable | recyclable | recyclable | recyclable |
| Performance | epoxy resin | epoxy resin | epoxy resin | epoxy resin | epoxy resin |
| Properties | system C | system D | system E | system F | system G |

The recyclable epoxy resin system

| | | | | | |
|---|---|---|---|---|---|
| Tensile | | | | | |
| Test | | | | | |
| Tensile | 73.79 | 72.87 | 72.00 | 71.87 | 72.03 |
| Strength | | | | | |
| Tensile | 4.23 | 4.62 | 4.38 | 4.34 | 4.30 |
| Strain | | | | | |
| E-Modulus | 3,001 | 2,972 | 2,892 | 2,890 | 2,893 |
| Flexural | | | | | |
| Test | | | | | |
| Flexural | 125.34 | 123.44 | 124.33 | 125.66 | 122.54 |
| Strength | | | | | |
| Flexural | 5.69 | 5.87 | 5.78 | 5.88 | 5.07 |
| Strain | | | | | |
| E-Modulus | 3,206 | 3,108 | 3,200 | 3,100 | 3,236 |

Glass or carbon reinforced epoxy composite laminates

| | | | | | |
|---|---|---|---|---|---|
| Tensile test | | | | | |
| 0° (UD) | | | | | |
| Tensile | 851.70 | 848.48 | 850.26 | 849.23 | 856.10 |
| strength | | | | | |
| Fracture | 2.08 | 2.00 | 1.99 | 2.05 | 2.03 |
| strain | | | | | |
| Modulus | 44,210 | 43,607 | 44,010 | 43,900 | 43,303 |
| (Chord 0.05% | | | | | |
| 0.25%) | | | | | |
| Shear test ± | | | | | |
| 45° 2Ax | | | | | |
| Shear | 42.43 | 44.37 | 43.80 | 45.14 | 43.71 |
| strength | | | | | |
| (at 5% | | | | | |
| shear | | | | | |
| strain) | | | | | |
| Shear | 3,184 | 3,233 | 3,334 | 3,455 | 3,310 |
| modulus | | | | | |

### Observations:

The performance properties of the recyclable epoxy resin system are comparable with the conventional epoxy resin system.

TABLE 7
Performance Properties of the slow reacting recyclable epoxy resin system A to G in
accordance with the present disclosure vis-à-vis the slow reacting epoxy
resin system 1, 2, 3, 4, 5 and 6 of Indian Patent application No. 201711032920

| | | | | | | | | |
|---|---|---|---|---|---|---|---|---|
| | | | Slow | Slow | Slow | Slow | Slow | Slow |
| | | | reacting | reacting | reacting | reacting | reacting | reacting |
| | | | epoxy | epoxy | epoxy | epoxy | epoxy | epoxy |
| Performance | Test | | resin | resin | resin | resin | resin | resin |
| Properties | method | Unit | system 1 | system 2 | system 3 | system 4 | system 5 | system 6 |

Epoxy resin

| | | | | | | | | |
|---|---|---|---|---|---|---|---|---|
| Tensile | ISO | | | | | | | |
| Test | 527-2 | | | | | | | |
| Tensile | | MPa | 71.32 | 68.62 | 71.02 | 69.04 | 70.54 | 67.24 |
| Strength | | | | | | | | |
| Tensile | | % | 4.62 | 4.42 | 5.05 | 5.23 | 4.82 | 5.41 |
| Strain | | | | | | | | |
| E-Modulus | | MPa | 2,923 | 2,902 | 2,865 | 2,841 | 2,822 | 2,731 |
| Flexural | ISO | | | | | | | |
| Test | 178 | | | | | | | |
| Flexural | | MPa | 117.06 | 115.20 | 123.82 | 121.01 | 116.55 | 112.28 |
| Strength | | | | | | | | |
| Flexural | | % | 5.95 | 5.74 | 6.37 | 6.34 | 5.49 | 6.79 |
| Strain | | | | | | | | |
| E-Modulus | | MPa | 3,091 | 3,038 | 3,076 | 3,003 | 3,079 | 2,812 |

Glass or carbon reinforced epoxy composite laminates

| | | | | | | | | |
|---|---|---|---|---|---|---|---|---|
| Shear | ISO | | | | | | | |
| test ± | 14129 | | | | | | | |
| 45° 2Ax | | | | | | | | |
| Shear | | MPa | 38.98 | 40.17 | 42.57 | 39.33 | 42.76 | 38.02 |
| strength | | | | | | | | |
| (at 5% | | | | | | | | |
| shear | | | | | | | | |
| strain) | | | | | | | | |
| Shear | | MPa | 3,234 | 3,400 | 3,273 | 3,327 | 3,484 | 3,180 |
| modulus | | | | | | | | |

| | Slow | Slow | | Slow | Slow | Slow | Slow |
|---|---|---|---|---|---|---|---|
| | reacting | reacting | Slow | reacting | reacting | reacting | reacting |
| | recyclable | recyclable | reacting | recyclable | recyclable | recyclable | recyclable |
| | epoxy | epoxy | epoxy | epoxy | epoxy | epoxy | epoxy |
| Performance | resin | resin | resin | resin | resin | resin | resin |
| Properties | system A | system B | system C | system D | system E | system F | system G |
| Epoxy resin | | | | | | | |
| Tensile | | | | | | | |
| Test | | | | | | | |
| Tensile | 71.53 | 73.84 | 73.79 | 72.87 | 72.00 | 71.87 | 72.03 |
| Strength | | | | | | | |
| Tensile | 4.34 | 4.76 | 4.23 | 4.62 | 4.38 | 4.34 | 4.30 |
| Strain | | | | | | | |
| E-Modulus | 3,018 | 2,870 | 3,001 | 2,972 | 2,892 | 2,890 | 2,893 |
| Flexural | | | | | | | |
| Test | | | | | | | |
| Flexural | 125.45 | 120.92 | 125.34 | 123.44 | 124.33 | 125.66 | 122.54 |
| Strength | | | | | | | |
| Flexural | 5.86 | 6.12 | 5.69 | 5.87 | 5.78 | 5.88 | 5.07 |
| Strain | | | | | | | |
| E-Modulus | 3,227 | 3,040 | 3,206 | 3,108 | 3,200 | 3,100 | 3,236 |
| Glass or carbon reinforced epoxy composite laminates | | | | | | | |
| Shear | | | | | | | |
| test ± | | | | | | | |
| 45° 2Ax | | | | | | | |
| Shear | 43.47 | 45.19 | 42.43 | 44.37 | 43.80 | 45.14 | 43.71 |
| strength | | | | | | | |
| (at 5% | | | | | | | |
| shear | | | | | | | |
| strain) | | | | | | | |
| Shear | 3,554 | 3,554 | 3,184 | 3,233 | 3,334 | 3,455 | 3,310 |
| modulus | | | | | | | |

### Observations:

As it can be observed from table 7 above, the shear strength of the composite made from the slow reacting recyclable epoxy resin systems A to G is in the range of 42.43 MPa to 45.19 MPa. Higher shear strength is indicative of improved coupling between the reinforcement material and the slow reacting recyclable epoxy resin system which is responsible for increased mechanical strength of the composite.

### Example 2: Reworkability and Recyclability of the Epoxy Resin System in Accordance with the Present Disclosure

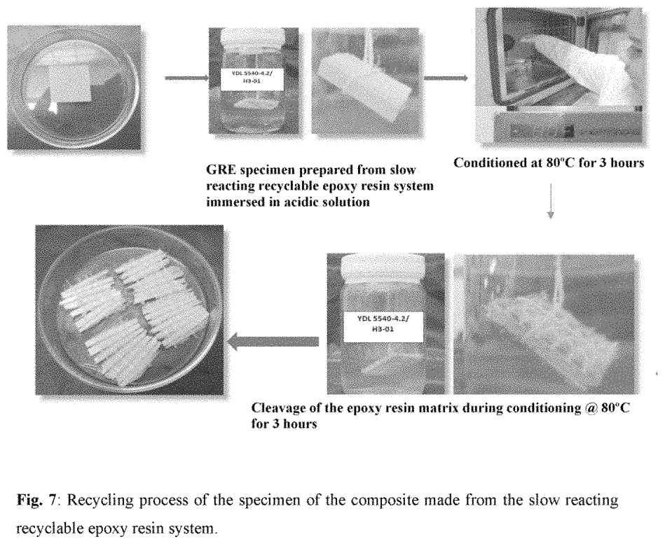

Specimen of the glass fiber composite made from the slow reacting recyclable epoxy resin system of the present disclosure was kept in the acetic acid solution at 80° C. temperature for 3 hours. Within an hour the specimen started to soften due to cleavage of epoxy resin matrix in the acetic acid solution. Within 3 hours, the epoxy resin matrix completely cleaved, dissolved and separated away from the reinforcement material. The reinforcement material was dried and is recovered for reuse, while the epoxy resin component (s) dissolved in acetic acid solution was neutralized and coagulated to form thermoplastic polymer. FIG. 7 shows the recycling process of the specimen of the composite made from the slow reacting recyclable epoxy resin system in accordance with an embodiment of the present disclosure.

### Specific Embodiments are Disclosed Below

A slow reacting recyclable epoxy resin system for structural composites, the slow reacting recyclable epoxy resin comprising an epoxy resin component comprising a high purity epoxy resin selected from a high purity Bisphenol A (BPA) epoxy resin, a high purity Bisphenol F (BPF) epoxy resin and a combination thereof, wherein the high purity epoxy resin is in a range of 20 to 95 wt. % of the total weight of the epoxy resin component, a standard epoxy resin selected from a standard bisphenol A (BPA) epoxy resin, a standard Bisphenol F (BPF) epoxy resin and a combination thereof wherein the standard epoxy resin is in a range of 1 to 50 wt. % of the total weight of the epoxy resin component; and a curing agent component comprising a curing agent having at least one cleavage linkage selected from a group comprising of an acetal linkage, a ketal linkage, a formal linkage, an orthoester linkage or a siloxy linkage.

Such slow reacting recyclable epoxy resin system, the epoxy resin component comprises the high purity Bisphenol A (BPA) epoxy resin in a range of 20 to 60 wt. % of the total weight of the epoxy resin component, the high purity Bisphenol F (BPF) epoxy resin in a range of 20 to 50 wt. % of the total weight of the epoxy resin component, and the standard epoxy resin in a range of 5 to 40 wt. % of the total weight of the epoxy resin component.

Such slow reacting recyclable epoxy resin system, wherein the curing agent is selected from a group comprising of 2,2-bis (2-aminopropoxy) propane, and tri (2-aminobutoxy) methyl silane.

Such slow reacting recyclable epoxy resin system, wherein the curing agent is in a range of 80 to 100 wt. % of the total weight of the curing agent component.

Such slow reacting recyclable epoxy resin system, wherein the high purity Bisphenol A (BPA) epoxy resin has an epoxy equivalent weight in a range of 170 to 183 gm/eq.

Such slow reacting recyclable epoxy resin system, wherein the high purity Bisphenol F (BPF) epoxy resin has an epoxy equivalent weight in a range of 155 to 165 gm/eq.

Such slow reacting recyclable epoxy resin system, wherein the standard Bisphenol A (BPA) epoxy resin has an epoxy equivalent weight in a range of 184 to 190 gm/eq.

Such slow reacting recyclable epoxy resin system, wherein the standard Bisphenol F (BPF) epoxy resin has an epoxy equivalent weight in a range of 170 to 180 gm/eq.

Such slow reacting recyclable epoxy resin system, wherein the epoxy resin component has by-products and impurities is less than 6000 ppm.

Such slow reacting recyclable epoxy resin system, wherein the high purity Bisphenol A (BPA) epoxy resin has a monomer content in a range of 85 to 99.9%.

Such slow reacting recyclable epoxy resin system, wherein the w/w ratio of the epoxy resin component to the curing agent component is in a range of 100:10 to 100:50.

Such slow reacting recyclable epoxy resin system, further comprising additives selected from the group consisting of modifiers, diluents or combination thereof.

Such slow reacting recyclable epoxy resin system, wherein the epoxy resin component further comprises a diluent selected from a group comprising of 1,4 butane diol diglycidyl ether, C12-C14 alkyl glycidyl ether, 1,6-hexanediol diglycidyl ether, cresyl glycidyl ether, trimethylolpropane triglycidyl ether or a combination thereof.

Such slow reacting recyclable epoxy resin system, wherein the epoxy resin component further comprises a high purity epoxidized reactive diluent selected from a group comprising of a high purity 1-4 butane diol diglycidyl ether, a high purity 1-6 hexanediol diglycidyl ether, a high purity cresyl glycidyl ether, a high purity trimethylolpropane triglycidyl ether and a combination thereof.

Such slow reacting recyclable epoxy resin system, wherein the initial mix viscosity after mixing the epoxy resin component and the curing agent component is less than 220 mPa·s at 25° C.

Such slow reacting recyclable epoxy resin system, wherein the initial mix viscosity after mixing the epoxy resin component and the curing agent component is less than 200 mPa·s at 40° C.

Such slow reacting recyclable epoxy resin system, having a pot life of more than 540 minutes at 25° C. and a glass transition temperature of more than 75° C.

Such slow reacting recyclable epoxy resin system, for use as structural composite wherein the strength development (Tg) is achieved in 6 hours @ 70° C.

A slow reacting recyclable epoxy resin system for structural composites, the slow reacting recyclable epoxy resin system comprising an epoxy resin component selected from a group comprising of a high purity Bisphenol A (BPA) epoxy resin, a high purity Bisphenol F (BPF) epoxy resin and a combination thereof and; a curing agent component comprising a curing agent having at least one cleavage linkage selected from a group comprising of an acetal linkage, a ketal linkage, a formal linkage, an orthoester linkage or a siloxy linkage.

Such slow reacting recyclable epoxy resin system, wherein the epoxy resin component comprises 50 to 85 wt. % of the high purity Bisphenol A (BPA) epoxy resin, and 25 to 50 wt. % of the high purity Bisphenol F (BPF) epoxy resin of the total weight of the epoxy resin component.

Such slow reacting recyclable epoxy resin system, wherein the curing agent is selected from a group comprising of 2,2-bis (2-aminopropoxy) propane, and tri (2-aminobutoxy) methyl silane.

Such slow reacting recyclable epoxy resin system, wherein the curing agent is in a range of 80 to 100 wt. % of the total weight of the curing agent component.

Such slow reacting recyclable epoxy resin system, wherein the high purity Bisphenol A (BPA) epoxy resin and the high purity Bisphenol F (BPF) epoxy resin has an epoxy equivalent weight in a range of 170 to 183 gm/eq and 155 to 165 gm/eq respectively.

Such slow reacting recyclable epoxy resin system, wherein the w/w ratio of the epoxy resin component to the curing agent component is in a range of 100:10 to 100:50.

Such slow reacting recyclable epoxy resin system is having a pot life of more than 500 minutes at 25° C. and a glass transition temperature of more than 75° C.

A process for recycling a composite prepared from the slow reacting recyclable epoxy resin system. The process comprising immersing the composite in an acid solution at a temperature in a range of 70° C. to 90° C. and recovering of a reinforcement material and the conversion of the epoxy resin component (s) into a thermoplastic polymer.

### INDUSTRIAL APPLICABILITY

The slow reacting recyclable epoxy resin system of the present disclosure possesses suitable processing and performance properties, with the added benefit of recyclability and reworkability. The slow reacting recyclable epoxy resin system in accordance with the present disclosure possesses desirable processing and performance properties suitable for wide ranging composite processes such as infusion, wet lay-up, filament winding and pultrusion for applications in various structural composites including fiber-reinforced composites. Examples of such composites include but not limited to aerodynamic wings, wind turbine blades, automobile components, sports and recreational composites, construction, etc. The recyclable and reworkable slow epoxy resin system disclosed herein offers several advantages which include fast strength development, longer pot-life, high cross-link density and good fiber wetting property that enables composite parts without dry spots, wrinkles and surface defects.

The processing and the performance properties of the slow reacting recyclable epoxy resin system are particularly advantageous for windmill application in the manufacturing of wind turbine rotor blades. The slow reacting recyclable epoxy resin system of the present disclosure allows the manufacturing of longer and higher megawatt rating blades. The fast strength development of the present disclosure possesses potential to improve productivity in wind blade manufacturing. The slow reacting recyclable epoxy resin system in accordance with the present disclosure offers a unique solution as it meets the blade designer's need for new materials for aerodynamic-longer-higher power rating blades as well as the blade manufacturer's cost targets by serving to reduce manufacturing and process defects and increasing productivity.

The composite materials made from the slow reacting recyclable epoxy resin system can also be recycled and recovered under specific conditions, leading to the separation and recovery of both the reinforcing material and the epoxy resin component(s) in the form of thermoplastic material. These composite materials can be recycled precisely because the epoxy matrix of a fabricated composite is derived from the recyclable curing agent component (s). The recycling nature of the epoxy resin system (s) helps in recovering the reinforcement material and other valuable components in a composite and provides a sustainable solution that contributes to the circular economy.

We claim:

1. A slow reacting recyclable epoxy resin system for structural composites comprising:
an epoxy resin component comprising
a high purity epoxy resin selected from a high purity Bisphenol A (BPA) epoxy resin, a high purity Bisphenol F (BPF) epoxy resin and a combination thereof, wherein the high purity epoxy resin is in a range of 20 to 95 wt. % of the total weight of the epoxy resin component,
a standard epoxy resin selected from a standard bisphenol A (BPA) epoxy resin, a standard Bisphenol F (BPF) epoxy resin and a combination thereof, wherein the standard epoxy resin is in a range of 1 to 50 wt. % of the total weight of the epoxy resin component; and
a curing agent component comprising a curing agent having at least one cleavage linkage selected from a group comprising of an acetal linkage, a ketal linkage, a formal linkage, an orthoester linkage or a siloxy linkage.

2. The slow reacting recyclable epoxy resin system as claimed in claim 1, wherein the epoxy resin component comprises the high purity Bisphenol A (BPA) epoxy resin in a range of 20 to 60 wt. % of the total weight of the epoxy resin component, the high purity Bisphenol F (BPF) epoxy resin in a range of 20 to 50 wt. % of the total weight of the epoxy resin component, and the standard epoxy resin in a range of 5 to 40 wt. % of the total weight of the epoxy resin component.

3. The slow reacting recyclable epoxy resin system as claimed in claim 1, wherein the curing agent is selected from a group comprising of 2,2-bis (2-aminopropoxy) propane, and tri (2-aminobutoxy) methyl silane.

4. The slow reacting recyclable epoxy resin system as claimed in claim 1, wherein the curing agent is in a range of 80 to 100 wt. % of the total weight of the curing agent component.

5. The slow reacting recyclable epoxy resin system as claimed in claim 1, wherein the high purity Bisphenol A (BPA) epoxy resin has an epoxy equivalent weight in a range of 170 to 183 gm/eq.

6. The slow reacting recyclable epoxy resin system as claimed in claim 1, wherein the high purity Bisphenol F (BPF) epoxy resin has an epoxy equivalent weight in a range of 155 to 165 gm/eq.

7. The slow reacting recyclable epoxy resin system as claimed in claim 1, wherein the standard Bisphenol A (BPA) epoxy resin has an epoxy equivalent weight in a range of 184 to 190 gm/eq.

8. The slow reacting recyclable epoxy resin system as claimed in claim 1, wherein the standard Bisphenol F (BPF) epoxy resin has an epoxy equivalent weight in a range of 170 to 180 gm/eq.

9. The slow reacting recyclable epoxy resin system as claimed in claim 1, wherein the epoxy resin component has by-products and impurities is less than 6000 ppm.

10. The slow reacting recyclable epoxy resin system as claimed in claim 1, wherein the high purity Bisphenol A (BPA) epoxy resin has a monomer content in a range of 85 to 99.9%.

11. The slow reacting recyclable epoxy resin system as claimed in claim 1, wherein the w/w ratio of the epoxy resin component to the curing agent component is in a range of 100:10 to 100:50.

12. The slow reacting recyclable epoxy resin system as claimed in claim 1, further comprising additives selected from the group consisting of modifiers, diluents or combination thereof.

13. The slow reacting recyclable epoxy resin system as claimed in claim 1, wherein the epoxy resin component further comprises a diluent selected from a group comprising of 1,4 butane diol diglycidyl ether, C12-C14 alkyl glycidyl ether, 1,6-hexanediol diglycidyl ether, cresyl glycidyl ether, trimethylolpropane triglycidyl ether or a combination thereof.

14. The slow reacting recyclable epoxy resin system as claimed in claim 1, wherein the epoxy resin component further comprises a high purity epoxidized reactive diluent selected from a group comprising of a high purity 1-4 butane diol diglycidyl ether, a high purity 1-6 hexanediol diglycidyl ether, a high purity cresyl glycidyl ether, a high purity trimethylolpropane triglycidyl ether or a combination thereof.

15. The slow reacting recyclable epoxy resin system as claimed in claim 1, wherein the initial mix viscosity after mixing the epoxy resin component and the curing agent component is less than 220 mPa·s at 25° C.

16. The slow reacting recyclable epoxy resin system as claimed in claim 1, wherein the initial mix viscosity of the slow reacting recyclable epoxy resin system after mixing the epoxy resin component and the curing agent component is less than 200 mPa·s at 40° C.

17. The slow reacting recyclable epoxy resin system as claimed in claim 1, having a pot life of more than 540 minutes at 25° C. and a glass transition temperature of more than 75° C.

18. The slow reacting recyclable epoxy resin system as claimed in claim 1, for use as structural composite wherein the strength development (T_{g}) is achieved in 6 hours @ 70° C.

19. A slow reacting recyclable epoxy resin system for structural composites comprising:
an epoxy resin component selected from a group comprising of a high purity Bisphenol A (BPA) epoxy resin, a high purity Bisphenol F (BPF) epoxy resin and a combination thereof and;
a curing agent component comprising a curing agent having at least one cleavage linkage selected from a group comprising of an acetal linkage, a ketal linkage, a formal linkage, an orthoester linkage or a siloxy linkage.

20. The slow reacting recyclable epoxy resin system as claimed in claim 19, wherein the epoxy resin component comprises 50 to 85 wt. % of the high purity Bisphenol A (BPA) epoxy resin, and 25 to 50 wt. % of the high purity Bisphenol F (BPF) epoxy resin of the total weight of the epoxy resin component.

21. The slow reacting recyclable epoxy resin system as claimed in claim 19, wherein the curing agent is selected from a group comprising of 2,2-bis (2-aminopropoxy) propane, and tri (2-aminobutoxy) methyl silane.

22. The slow reacting recyclable epoxy resin system as claimed in claim 19, wherein the curing agent is in a range of 80 to 100 wt. % of the total weight of the curing agent component.

23. The slow reacting recyclable epoxy resin system as claimed in claim 19, wherein the high purity Bisphenol A (BPA) epoxy resin and the high purity Bisphenol F has an epoxy equivalent weight in a range of 170 to 183 gm/eq and 155 to 165 gm/eq.

24. The slow reacting recyclable epoxy resin system as claimed in claim 19, wherein the w/w ratio of the epoxy resin component to the curing agent component is in a range of 100:10 to 100:50.

25. The slow reacting recyclable epoxy resin system as claimed in claim 19, is having a pot life of more than 540 minutes at 25° C. and a glass transition temperature of more than 75° C.

26. A process for recycling a composite prepared from the slow reacting recyclable epoxy resin system as claimed in claim 1 or claim 19, the process comprising:
immersing the composite in an acid solution at a temperature in a range of 70° C. to 90° C.; and
recovering of a reinforcement material and the conversion of the epoxy resin component (s) into a thermoplastic polymer.
